(19) United States
(12) Patent Application Publication
(10) Pub. No.: US 2005/0278151 A1
(43) Pub. Date: Dec. 15, 2005

(54) Computer rack diagram creation

(76) Inventor: William Bechtel Stayer, Portland, OR (US)

Correspondence Address: LIEBERMAN & BRANDSDORFER, LLC, 802 STILL CREEK LANE, GAITHERSBURG, MD, 20878, US

(21) Appl. No.: 10/857,071

(22) Filed: May 28, 2004

(51) Int. Cl. G06F 17/50

(52) U.S. Cl. 703/1

(57) ABSTRACT

A method of designing a system cabinet configuration and generating an illustration of the cabinet system and components. The method of designing a configurable system incorporates the act of acquiring an initial product requirement for a system, filtering the initial product requirement to determine an initial cabinet structure, and automatically generating the configuration for the final cabinet design based upon the initial product requirements and the filtered product requirements. The method may also include the configuration of a system using a primary and expansion cabinet(s). The method may also incorporate the use of a rule set array and/or priority racking table. The method may also provide that the priority racking table will identify a sequence for placing components in the cabinet.

### BACKGROUND OF THE INVENTION

1. Technical Field

This invention relates to a method and system for creating a rack diagram of a computer system. More specifically, the configurable computer system is designed and configured in an automated fashion.

2. Description Of The Prior Art

A distributed or cluster computer system is generally housed in a computer cabinet that is designed to hold components of the system therein. The cabinet is designed to accommodate the components so that they interconnect and communicate. The components may include servers, switching equipment, storage components, routers, etc. A diagram of a computer system illustrating the cabinet and the components housed in the cabinet generally includes a cabinet frame with select space in the cabinet designated for different components that are a part of the system. Each component is sized with the same width and depth to fit within the vertical walls of the cabinet. However, different components may have different height sizes. For example, a server, or different servers, may be the same width and depth, but have a different height, and therefore occupy different amounts of available space in a computer cabinet. In an ideal scenario, components should be placed in locations within a cabinet that will provide optimal component and system performance taking into account the physical characteristics and requirements of the cabinet and the components placed within the cabinet. For example, the cabinet should include sufficient spacing between adjacently stacked components to enable the optimal volume of cooling air to pass between components based upon the use of a selected cabinet and selected components to prevent overheating of any of the components.

A distributed or cluster computer system will generally utilize one or more cabinets in the system. Generally, in situations where multiple cabinets are required, a cabinet configuration using a primary cabinet with expansion cabinets is utilized. A primary cabinet generally houses a management server, a console, and any required switching equipment for the system. Additional components that do not fit in the primary cabinet are housed in one or more expansion cabinets with the components housed in the expansion cabinets being in communication with the primary cabinet. Prior art methods of designing the layout and stacking of heterogeneous components in a cabinet of a computer system generally follow a set of known guidelines. For example, a computer cabinet will provide for the stacking of multiple components within the cabinet while maintaining the cabinet's stability and integrity. Stability is generally achieved by placing larger components of the system in a lower section of the cabinet, as a top heavy cabinet may be prone to shifting or collapse. Additionally, different components may require periodic servicing, and therefore may need to be physically located in an accessible region of the cabinet. However, there are no set rules and standards for determining optimal placement of different components, or for determining which components are optimal for placement in a primary computer cabinet or an expansion cabinet. In addition, there is no system for efficiently illustrating the placement of the different components in the primary or expansion cabinet. Provision of an illustration is beneficial to provide a look and feel for the final computer system layout.

Therefore, there is a need for a method and system that automates the process of designing a layout of a computer system within one or more computer cabinets. In addition, the method and system should provide an illustration showing the position of each of the components within an assigned cabinet.

### SUMMARY OF THE INVENTION

The present invention comprises a method and system for automating physical placement of components of a computer system.

In a first aspect of the invention, a method is provided for designing a configurable system. An initial product requirement is acquired. Thereafter, the initial product requirement is filtered to determine a cabinet structure. Following the acquisition and filtering of product requirements, a final cabinet design based upon the initial product requirement and the filtered product requirement is configured.

In another aspect of the invention, a system is provided for designing a cabinet layout. A filter is provided to determine an initial cabinet structure based upon an initial product requirement. A design manager is provided to automate configuration of a final cabinet design based upon the initial cabinet structure and the filtered product requirement.

In yet another aspect of the invention, an article is provided in a computer-readable signal bearing medium. Means in the medium are provided for acquiring an initial product requirement. In addition, means in the medium are provided for determining a cabinet structure, and for configuring a final cabinet design based upon the initial product requirement and the determined cabinet structure.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart illustrating configuration of configurable computer system according to the preferred embodiment of this invention, and is suggested for printing on the first page of the issued patent.

FIG. 2 is a diagram of a skeleton primary computer cabinet.

FIG. 3 is a diagram of a stacked primary cabinet and a stacked expansion cabinet.

### DESCRIPTION OF THE PREFERRED EMBODIMENT

### Overview

A tool for automating configuration of a cabinet diagram is provided. The tool allows a user to input product requirements into a software interface. Based upon the user input, an initial primary cabinet is selected, drawn and presented to the user. In addition, expansion cabinets may be drawn and presented to the user if additional cabinets are required to house the selected components.

### Technical Details

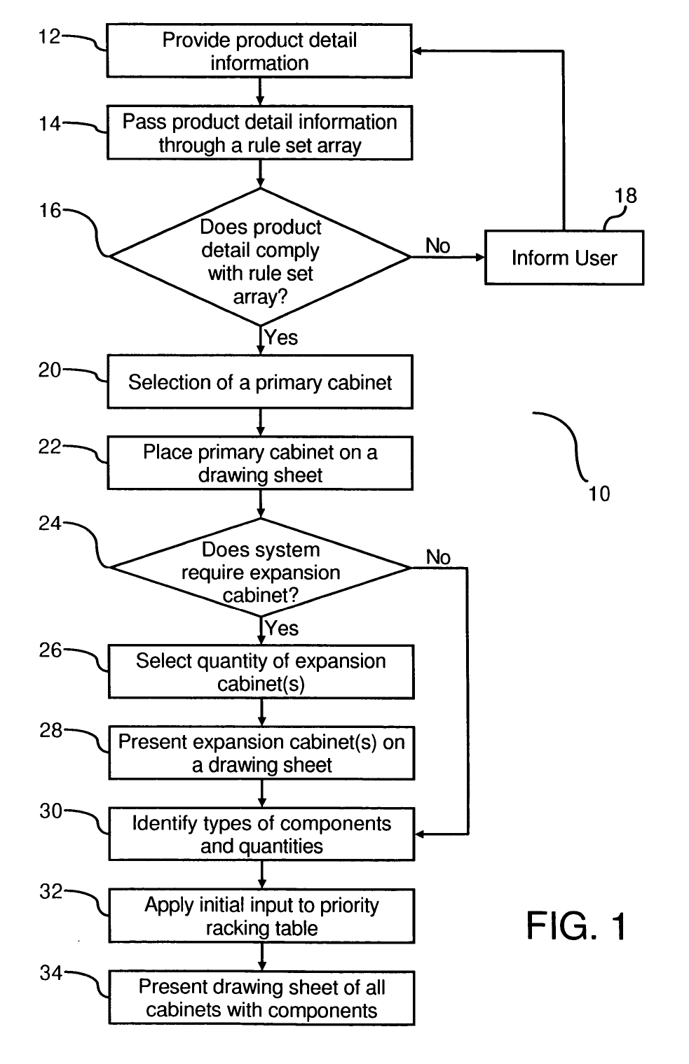

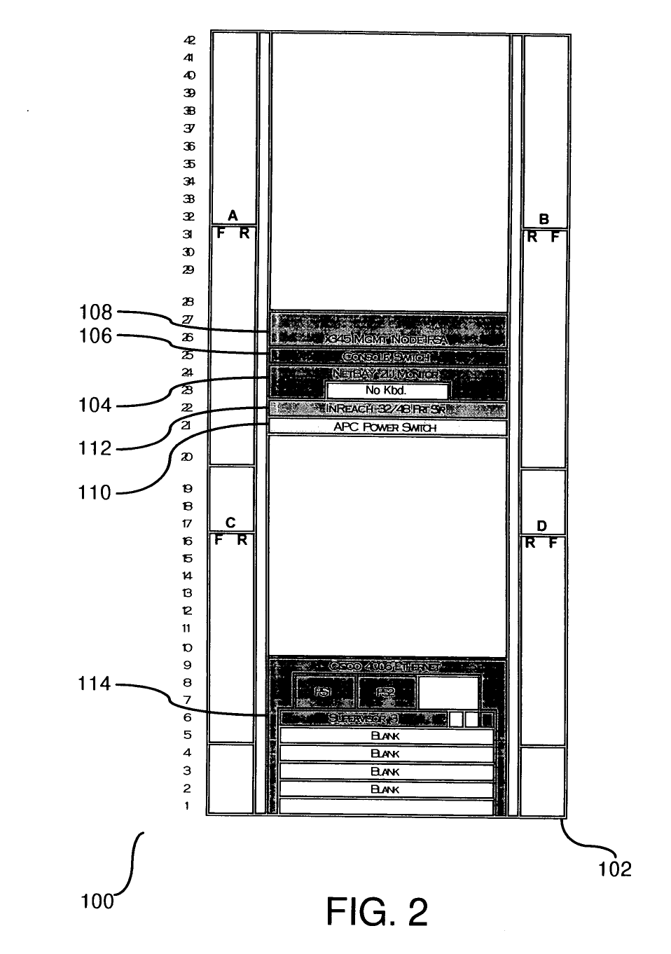

FIG. 1 is a flow chart (10) illustrating the process of designing a configurable system and presenting a final design drawing. The first step in the process is for a user to provide information of the product detail (12). In one embodiment, the cabinet may be used to house components of a computer system and a rule set array may be used to filter key aspects of configuration of the system to select an appropriate primary cabinet. For explanatory purposes, the invention will be described in detail for a computer system housed in one or more cabinets. In one embodiment, the product detail is entered into a computer readable medium. The product detail may include the amount of processing projected, the communication requirements, and storage information detail. Additionally, the product detail may also include the quantity and type of server nodes, quantity and types of switches, quantity and types of storage media, etc. Each component of the product detail that is selected for the system will eventually be physically housed in a cabinet. Each cabinet has multiple drawers, with each drawer designed to house components of the system. Once the user has provided the product detail, this information is passed through a rule set array (14). The rule set array is used to determine an initial primary cabinet based upon the user input information. It should be noted, in a computer system the primary cabinet is used to house the management server node. An initial primary computer cabinet may be selected from an array of primary cabinets with different configurations based upon engineering a manufacturer parameters. FIG. 2 is a diagram (100) of one embodiment of a primary computer cabinet (102) prior to installation of any components. As shown, the primary computer cabinet (102) may be preset to include a console (104), a keyboard (106), a management server (108), and switching equipment (110), wherein the switching equipment generally includes a console switch (112) and a remote control power switch (114). Different components may be placed in different drawers of the primary cabinet based upon desired and required accessibility of the component.

Following step (14), a test is conducted to determine if the product detail provided at step (12) complies with the rule set array requirements (16). If the response to the test at step (16) is negative, the user is informed of the non-compliance (18) and returns to step (12) to provide product detail that may comply with the rule set array. However, a positive response to the test at step (16), results in an initial selection of a primary cabinet from a group of primary cabinets designs (20) as designated by the rule set array at step (14). The initial selection is a skeleton cabinet as it only includes limited components of the system. The primary cabinet selected by the rule set array is placed on a drawing sheet for presentation (22). Accordingly, the first part of the system design process presents an initial drawing sheet and a predrawn outline of an optimal primary cabinet based upon product detail received at step (12).

Following the presentation of the primary cabinet, a test is conducted to determine if any expansion cabinets are required (24). In one embodiment, the test may entail calculating the number of expansion cabinets based upon essential components provided at step (12) that require ancillary components to support functionality. Expansion cabinets are additional cabinets that are used to house components of the system that do not fit within the physical confines of the primary cabinet based upon the quantity of components required for the system. Each of the components housed in a secondary cabinet are in communication with the components housed in the primary cabinet. A positive response to the test at step (24) will result in selection of a required quantity of expansion cabinets (26). Each of the expansion cabinets are then presented on a drawing sheet (28). Depending on the quantity of total cabinets, i.e. primary and expansion cabinets, the expansion cabinets may be placed on the same initial drawing sheet as the primary cabinet or on a separate drawing sheet.

Following the determination of the quantity of expansion cabinets required, or a negative response to the test at step (24), the types and quantity of items to be placed in the cabinet(s) need to be identified (30). In one embodiment, an exact number of computer servers to be housed in one or more cabinets may be taken from user input provided at step (12). Alternatively, the type and quantity of server and/or non-server components to be housed in one or more cabinets may be derived from the quantity of servers and product detail specified at step (12). For example, the product detail at step (12) may provide a specific communication switch, but may not specify the size of the switch. Different size switches may require different quantities of support components. Therefore, the initial product input is entered into a priority racking table to identify the components of the system and the order of placement of the individual components in the cabinet(s) (32). In addition, the priority racking table determines which identified components are to be placed into the primary cabinet, and which components are to be placed into the expansion cabinet(s), if any. In one embodiment, the priority of a component may include factors such as size and weight. The individual components are preferably vertically arranged in the cabinet based upon size, weight, and desired accessibility to the component. Once the items have been virtually placed in the cabinet(s), a complete drawing of each of the computer cabinets is presented on a drawing sheet (34). Accordingly, the product detail is placed through a rule set array and a priority racking table to determine the quantity of computer cabinets and quantity of components for placement in the cabinets to complete the computer system.

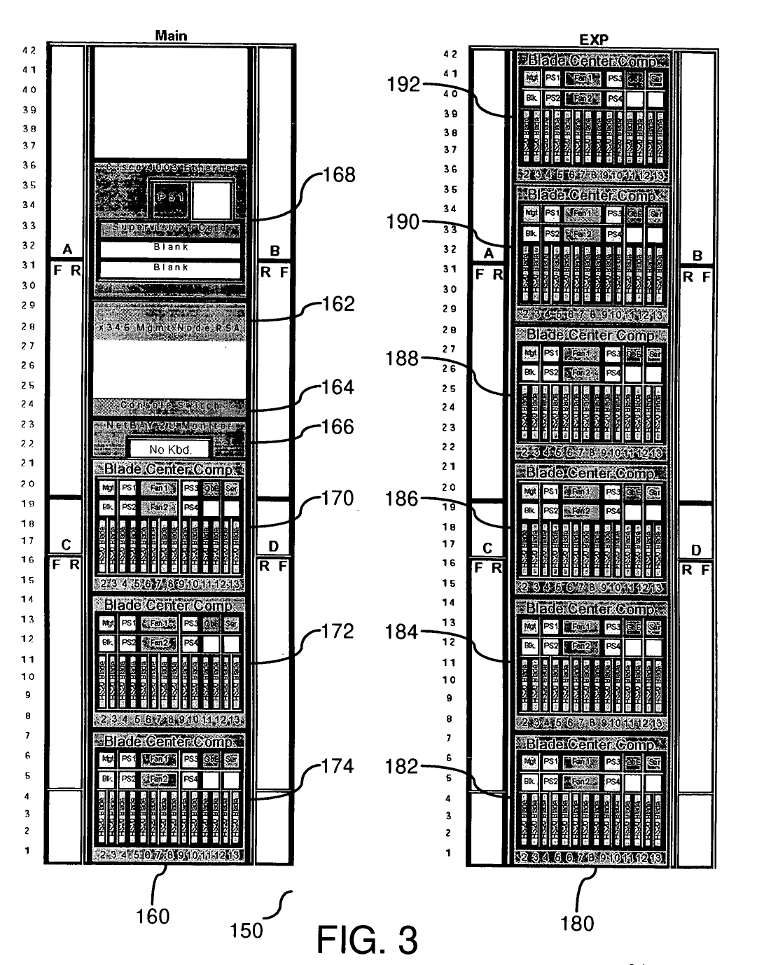

FIG. 3 is an illustration (150) of a computer system illustration at step (34) with one primary computer cabinet (160) and one expansion cabinet (180). Each of the cabinets has forty two drawers to accommodate up to forty two components. The primary cabinet (160) includes a management server node (162) with a console switch (164), a monitor without a keyboard (166), a communication switch (168), and three blade center chassis's (170), (172), and (174). The management server node (162) and console switch occupies six drawers. The monitor without the keyboard (166) accommodates two drawers. As shown, the monitor without the keyboard (166) has a position within the cabinet that enables an operator to view the monitor. Each of the blade center chassis's (170), (172), and (174) occupies seven drawers. The blade center chassis's are placed in the bottom half of the primary cabinet based upon size and weight. The expansion computer cabinet (180) includes six blade center chassis's (182), (184), (186), (188), (190), and (192). Since each of the blade center chassis's has an identical external size, they are stacked evenly from the bottom drawer of the computer cabinet to the top drawer of the computer cabinet.

As shown in FIG. 1, product detail is provided in order to determine the initial primary cabinet and any expansion cabinets. In one embodiment, the rule set array and priority stacking table are placed in a computer readable medium. The initial product detail is entered into the medium. Thereafter, an operator may present queries to further identify the parameters of the system being configured. The drawing figures and all illustrations may also be presented in the computer readable medium, or on a hard copy.

### Advantages Over The Prior Art

The system enables an interested party to create and view an illustration of a computer system and the components therein stacked in one or more computer cabinets. With the exception of the initial product requirements, the selection of the primary computer cabinet and the quantity of expansion computer cabinets are determined by a rule set array. In addition, once the quantity of components and computer cabinets has been determined, a priority racking table determines the physical placement of each of the components in each of the computer cabinets. Following completion of the priority racking table, a final product illustration is created.

### Alternative Embodiments

It will be appreciated that, although specific embodiments of the invention have been described herein for purposes of illustration, various modifications may be made without departing from the spirit and scope of the invention. In particular, the final product diagram may also include a price quotation for costs associated with sale of the illustrated computer system. Additionally, a rule set array may incorporate parameters that provide rules beyond physical and operational parameters of the system, cabinets, and components such as dimension limitations for the complete system or cost factors for various computer cabinets or components. Finally, the cabinets may be used to house components of a computer system, a stereo system, or any element that may be stacked in a cabinet. Accordingly, the scope of protection of this invention is limited only by the following claims and their equivalents.

1. A method for designing a configurable system comprising:
acquiring an initial product requirement;
filtering said initial product requirement to determine a cabinet structure; and
automating configuration of a final cabinet design based upon said initial product requirement and said filtered product requirement.

2. The method of claim 1, wherein the step of filtering said initial product requirement includes calculating a quantity of required expansion cabinets.

3. The method of claim 1, wherein said cabinet is selected from a group consisting of: a primary cabinet and an expansion cabinet.

4. The method of claim 1, wherein the step of filtering said initial product requirement includes applying said product requirement to a rule set array.

5. The method of claim 1, further comprising applying said initial product requirement to a priority racking table to identify a sequence for placing components in said cabinet.

6. The method of claim 1, wherein the step of configuring a final computer cabinet design includes drawing a diagram of said final design.

7. A system comprising:
a filter adapted to determine an initial cabinet structure based upon an initial product requirement; and
a design manager adapted to automated configuration of a final cabinet design based upon said initial cabinet structure and said filtered product requirement.

8. The system of claim 7, wherein said manager is adapted to determine a quantity of required expansion cabinets.

9. The system of claim 7, wherein said cabinet is selected from a group consisting of: a primary cabinet and an expansion cabinet.

10. The system of claim 7, wherein said initial product requirement is adapted to be filtered through a rule set array.

11. The system of claim 10, further comprising a priority racking table adapted to identify a sequence for placement of components in said cabinet.

12. The system of claim 7, further comprising a diagram of a final computer cabinet design.

13. An article comprising:
a computer-readable signal-bearing medium;
means in the medium for acquiring an initial product requirement;
means in the medium for determining a cabinet structure; and
means in the medium for configuring a final cabinet design based upon said initial product requirement and said determined cabinet structure.

14. The article of claim 13, wherein said medium is selected from a group consisting of: a recordable data storage medium, and a modulated carrier signal.

15. The article of claim 13, wherein said means for determining a cabinet structure includes a filter adapted to calculate a quantity of required expansion cabinets.

16. The article of claim 15, wherein said filter is adapted to apply said product requirement to a rule set array.

17. The article of claim 13, further comprising means in the medium for applying said initial product requirement to a racking table to identify a sequence for placement of components in a cabinet.

18. The article of claim 13, wherein said cabinet is selected from a group consisting of: a primary cabinet and an expansion cabinet.

19. The article of claim 13, further comprising means in the medium for drawing a diagram of said final product design.

20. A method for designing a configurable computer system comprising:
acquiring an initial product requirement for said system;
filtering said initial product requirement to determine a primary cabinet structure; and
automating configuration of a final computer cabinet design based upon said initial product requirement and said filtered product requirement.
